(19) United States
(12) Patent Application Publication
(10) Pub. No.: US 2024/0330761 A1
(43) Pub. Date: Oct. 3, 2024

(54) SYSTEMS AND METHODS FOR CUSTOMIZING MACHINE LEARNING MODELS FOR PERMITTING DIFFERENT TYPES OF INFERENCES

(71) Applicant: CONSERVATION X LABS, INC., Washington DC, WA (US)

(72) Inventors: Samuel James Kelly, Arlington, VA (US); Chad Stephen Gallinat, Washington, WA (US); Henrik Thomas Oftedahl Cox, Washington DC, WA (US); Patrict Edward Charles COME, Evanston, IL (US); Paul BUNJE, Studio City, CA (US); Alex DEHGAN, Washington, WA (US)

(73) Assignee: CONSERVATION X LABS, INC., Washington DC, WA (US)

(21) Appl. No.: 18/293,376

(22) PCT Filed: Aug. 1, 2022
(86) PCT No.: PCT/US2022/039096

§ 371 Date: Jan. 30, 2024

Related U.S. Application Data
(60) Provisional application No. 63/227,355, filed on Jul. 30, 2021.

(51) Int. Cl. G06N 20/00

(52) U.S. Cl. CPC G06N 20/00

(57) ABSTRACT

A process for facilitating environmental conservation is described. The process includes: (i) creating a model for describing phenomena relevant to environmental conservation; (ii) training the model using machine-learning to produce a candidate model; (iii) determining whether the candidate model satisfies predetermined model statistics, and if not, repeating previous step until they are satisfied; (iv) deeming the candidate model as a deployable model if the predetermined model statistics are satisfied; (v) deploying the candidate model to permit an inference; (vi) determining whether the inference satisfies predefined inference criteria; (vii) deeming the deployable model as the final model if the predefined inference criteria are satisfied, and if not, modifying the deployable model until they are satisfied to produce the final model; (viii) implementing the final model on an AI adapter device remote to the user to draw an inference; and (ix) taking action using the AI adapter device to facilitate environmental conservation.

### RELATED CASE

This application claims priority to U.S. provisional application No. 63/227,355, filed on Jul. 30, 2021, which is incorporated herein by reference for all purposes.

### FIELD

The present teachings generally relate to systems and methods for customizing predetermined mathematical models, using artificial intelligence (“AI”), based on data collected in the field, to permit an inference. More particularly, the present teachings relate to systems and methods for customizing predetermined mathematical models, based upon data collected in the field and machine learning (“ML”), and deploying these modified customized models, on smart devices to allow remote users to draw an inference, and in particular, and inference related to facilitating conservation efforts.

### BACKGROUND

A domain expert, e.g., a wildlife conservation expert or an environmental expert, generally endeavors to gather field data and/or retrieve field data from existing channels and then processes the collected data to generate a mathematical model that describes a phenomenon. By way of non-limiting examples, such field data may be used to monitor for purposes of biosecurity (e.g., by detecting invasive and pest species), agricultural health and disease (e.g., by detecting diseases or infections in plants or animals), security and land management (e.g., by detecting trespassers), and illegal poaching and hunting (e.g., by detecting the presence of predators or hunters).

Unfortunately, this undertaking is sometimes very time-consuming, if not impossible, and generally cost-prohibitive. By way of example, the domain expert must expend significant effort or incur significant financial resources, e.g., manual labor and overhead costs, to retrieve and process data through field monitoring technologies and/or existing channels. As another example, even if data is obtained by surmounting these challenges, a combination of false negatives and false positives may render such data unreliable. As yet another example, due to inadequate communication infrastructure, areas of interest are often out of range, making data collection impossible or prohibitively expensive.

There are also instances when the domain experts are not skilled enough in software coding to exploit, and therefore do not have access to, artificial intelligence. When using publicly available, processed data, domain experts would like to have immediate access to such data, but such access is not available or very limited.

Likewise, it often takes too long to get data in a manner that enables rapid action. This problem is exacerbated when data is collected remotely, but immediate and remote intervention on site is not practicable.

Further, there is often more data than the bandwidth and/or capacity of the data processing resources to make it truly useful and actionable.

What is, therefore, needed are systems and methods that allow domain experts, including those that are remotely situated from a location or a site of interest, to develop and/or have access to customized mathematical models in a manner that decreases costs, increases outcomes, and enables immediate and remove interventions.

### SUMMARY

To achieve the foregoing, the present arrangements offer systems and methods for modifying predetermined mathematical models (e.g., animal or disease models) based upon machine learning and by filtering data received from monitoring technologies or sensor devices deployed in the field, such as audio and/or visual recording equipment (e.g., capable of recording image and/or video data). The present teachings also offer systems and methods for developing mathematical models that are deployable on smart devices present at a location or a site of interest and therefore capable of filtering and transmitting data (e.g., using resources available on or accessible through the Internet and/or the cloud) that is pertinent to the deployable model, in a relatively inexpensive and efficient manner, to a user (or a processor accessible by the user) present at a location remote to the location or the site of interest.

In one aspect, the present teachings disclose a process for facilitating environmental conservation. As used herein, environmental conservation means protecting and preserving natural resources and plant and animal life from deleterious effects of human activity. To this end, a process for facilitating environmental conservation, according to one preferred embodiment of the present arrangements, begins with a step of creating a mathematical model, using data and/or one or more data attributes. The model may be used in later steps for describing a phenomenon involving a human, animal, and/or plant presence or behavior at a location of interest. As one example, a user interested in facilitating environmental conservation may create a mathematical model configured to identify an endangered species of a particular type for purposes of tracking population levels of that species. Creating a mathematical model may further include steps of obtaining data (e.g., image, video, and/or acoustic data), labeling the data, and preparing the data for machine learning and/or training in subsequent steps.

The process for facilitating environmental conservation may then proceed to a step of training the mathematical model, according to on preferred embodiment of the present teachings, to arrive at a candidate model using the data, new data, one or more of the data attributes, and/or one or more new data attributes. Training is carried out by machine-learning techniques well-known to those of skill in the art for creating a mathematical model.

Following the training step, the process for facilitating environmental conservation proceeds to determining whether the candidate model satisfies one or more predefined model statistics. By way of non-limiting example, predefined model statistics may include accuracy, precision, recall, F1 Score, or Confusion Matrix.

If the candidate model does not satisfy the predefined model statistics, the previously mentioned steps of creating, training, and determining may be repeated until the candidate model satisfies the predefined model statistics. Once the candidate model satisfies one or more of the predefined model statistics, then the candidate model is deemed to be a deployable model.

In preferred embodiments of the present teachings, the steps of training the mathematical model, determining whether the candidate model satisfies one or more predefined model statistics, and deeming the deployable model to be a final model are carried out at a user computer or at a processor that is present at a location that is remote to the location of interest (e.g., in or accessible via the cloud).

The deployable model is then deployed to a user computer, an AI adapter device, and/or a remote processor (i.e., remote to a location of interest) to permit an inference regarding a phenomenon involving a human, animal, and/or plant presence or behavior at the location of interest. Preferably, the user computer and the remote processor are present at a location that is remote to the location of the AI adapter device.

The process for facilitating environmental conservation then proceeds to a step of determining whether the inference satisfies one or more predefined inference criteria, which may be thought of as criteria to evaluate the speed, precision, and accuracy of the inference. If the inference satisfies one or more of the predefined inference criteria, the deployable model is deemed a final model. If, however, the inference does not satisfy one or more of the predefined inference criteria, then the deployable manner is modified using one or more of the same steps of creating, training, and/or determining, preferably until one or more predefined inference criteria are satisfied according to this step.

Next, the final model is implemented on the AI adapter device, which is operating at the location of interest, to draw an inference. According to preferred embodiments of the present teachings, a particular inference may prompt further action that will facilitate environmental conservation efforts, e.g., by conserving human, animal, or plant life, as well as other natural resources. According to one preferred embodiment of the present teachings, taking action includes sending a notification to a user computer and/or a third party, setting a trap, sounding an alarm, recording an image or a video, recording a sound, depleting resources consumed by an invasive animal or a plant species, dispersing food, administering medicine or a vaccine, among other actions.

In another aspect, the present teachings disclose a process for allowing a user to automatically create a customized model that permits an inference, according to one preferred embodiment of the present teachings. The process may include steps of: (i) presenting a plurality of selectable predefined models, which were created using visual (e.g., video and/or image data) and/or audio data, on a user interface associated with a user computer; (ii) receiving, at the user computer, the user's selection of a selected predefined model; (iii) making available, on the user interface, the audio/visual data that was used to create the selected predefined model, such that the selected audio/visual data is capable of being sorted based upon different data attributes; (iv) receiving, at the user computer, identification of one or more relevant data and/or one or more relevant data attributes that allows sorting and selecting of relevant data from the selected audio/visual data and allows sorting and selecting of one or more of the relevant data attributes from the different data attributes; (v) training, using the relevant data and/or the relevant data attributes, the selected predefined model to arrive at a candidate model; (vi) determining whether the candidate model satisfies one or more predefined model statistics; and (vii) deeming the candidate model as a deployable model if the candidate model satisfies one or more of the predefined model statistics. If the candidate model does not satisfy the predefined model statistics, the process may further include repeating at least two of steps (ii)-(v) until the candidate model satisfies one or more of the predefined model statistics, to produce a deployable model. In other embodiments of the present teachings, however, data that is not audio or visual data are used to practice these steps.

In one preferred embodiment of the present arrangements, data attributes in step (v) above include at least one attribute chosen from a group comprising: date of creation of the relevant data, time of creation of the relevant data, location coordinates of location from where the relevant data was retrieved, species involved in the relevant data, and animal present in the relevant data.

Presenting and/or training may also include obtaining data, preferably visual and/or audio data, using one more visual and/or audio sensor devices.

In preferred embodiments of the present teachings, the process for allowing a user to automatically create a customized model that permits an inference includes further steps of (i) conveying operational instructions pertinent to one or more of the relevant data attributes to one or more controllers that control operation of the visual and/or audio sensors; and (ii) changing, based upon the operational instructions, operating conditions of the visual and/or audio sensors for collecting the relevant data to produce at least a portion of the relevant data. Changing operating conditions may include producing a portion of the relevant data, but not the entirety of the relevant data.

The process may further include steps of: (i) receiving relevant data that includes one or more usable portions (i.e., used for carrying out a training step) and one or more unusable portions, which are not capable of being used for carrying out of training; (ii) filtering out, using one or more algorithms, the unusable portions of relevant data; and (iii) training the selected predefined model using one or more usable portions of relevant data.

According to preferred embodiments of the present arrangements, once a deployable model has been produced, as described above, the process for allowing a user to automatically create a customized model that permits an inference includes further steps of: (i) deploying the deployable model in the user computer, an AI adapter device, or a remote processor (i.e., remote to the location of the AI adapter device) to permit an inference; (ii) determining whether the inference satisfies one or more predefined inference criteria; and (iii) deeming the deployable model as the final model if the inference satisfies one or more of the predefined inference criteria, or, modifying the deployable model if the inference does not satisfy one or more of the predefined inference criteria until the deployable model satisfies one or more of the predefined inference criteria, to produce the final model. The process may also include the further step of conveying the deployable model and/or audio and/or visual data associated with the deployable model from the user computer or the remote processor to the AI adapter device, if deeming is carried out by the user computer or the remote processor.

In preferred embodiments of the present arrangements, the process of allowing a user to automatically create a customized model that permits an inference further incudes steps of (i) implementing the final model on the AI adapter device; and (ii) taking an action, using the AI adapter device, at the location of interest to conserve human, animal and/or plant life. Conveying the final model to the AI adapter may include conveying from memory accessible by the user computer or remote memory accessible by the remote processor to the AI adapter device. Taking an action may include, but is not limited to, sending a notification to the user computer and/or a third party, setting a trap, sounding an alarm, recording an image or a video, recording a sound, depleting resources consumed by an invasive animal or a plant species, dispersing food, monitoring animal or plant health, and administering medicine or vaccine.

Implementing the final model on the AI adapter may also include conveying final data and/or final data attributes underlying the final model. Preferably, the final data includes one or more new data that is not present in the relevant data and/or does not include one or more excised data that were present in the relevant data; similarly, the final data attributes preferably include one or more new data attributes not present in the relevant data attributes and/or does not include one or more excised data attributes that were present in the relevant data attributes.

In yet another aspect, the present teachings and arrangements disclose a data processing device, and preferably, and audio or visual data (i.e., image and/or video data) processing device, comprising: (i) an audio sensor and/or a visual sensor, i.e., a sensor device; (ii) an AI adapter device comprising: (a) an audio controller and/or a visual controller that is designed to control operation of the audio sensor and/or the visual sensor, (b) an AI processor for processing data collected from the audio sensor and/or the visual sensor, and a power source for powering the AI processor. The present teachings recognize, however, that sensor devices that capture and record non-visual and/or non-audio data may be used.

In preferred embodiments of the present arrangements, the audio/visual data processing device includes a connecting component communicatively connecting the audio sensor and/or the visual sensor to the AI adapter device. For example, an AI adapter device and a sensor device may be connected by provisions for an SD card slot or a USB cable.

The audio/visual data collection device may also include a user computer or a remote processor, which has programmed thereon instructions for allowing a user to automatically create a customized model that permits an inference and/or deployment of the customized model to permit the inference. A remote process may be thought of as a processor that is at a location that is remote to the AI adapter device, including a remote processor that is accessible via the cloud. To this end, a memory accessible by the user computer or a remote memory accessible by the remote processor has stored thereon instructions for: (i) training a mathematical model to arrive at a candidate model using the data, new data, one or more of the data attributes, and/or one or more new data attributes; (ii) determining whether the candidate model satisfies one or more predefined model statistics; (iii) repeating the previous steps of creating, training and determining, if the candidate model does not satisfy one or more of the predefined model statistics, until the candidate model satisfies one or more of the predefined model statistics to produce a deployable model; (iv) deeming the candidate model as the deployable model if the candidate model satisfies one or more of the predefined model statistics; (v) deploying the deployable model to permit an inference; (vi) determining whether the inference satisfies one or more predefined inference criteria; (vii) deeming the deployable model as the final model if the inference satisfies one or more of the predefined inference criteria, and modifying the deployable model if the inference does not satisfy one or more of the predefined inference criteria, until the deployable model satisfies one or more of the predefined inference criteria to produce the final model; and (viii) conveying the final model to the AI adapter device.

According to one preferred embodiment of the present arrangements, the AI adapter device includes an AI processor, a communication component, and a power source on a single printed circuit board. In certain embodiments of the present arrangements, the AI processor is a central processing unit that includes the communication component, which serves to establish a wireless local area network connection. Preferably, the communication component is communicatively coupled to a cloud-based database.

The AI adapter device's printed circuit board may further include a long-range communication chip for communicating using low-power wide area network, cellular communications, or satellite communications.

According to one preferred embodiment of the present arrangements, the AI processor further includes an AI adapter device memory that stores instructions for: (i) deploying the deployable model to permit an inference; (ii) determining whether the inference satisfies one or more predefined inference criteria; (iii) deeming the deployable model as final model if the inference satisfies one or more of the predefined inference criteria, and modifying the deployable model if the inference does not satisfy one or more of the predefined inference criteria, until the deployable model satisfies one or more of the predefined inference criteria to produce the final model; (iv) implementing the final model to draw an inference; and (v) taking an action at the location of interest.

The AI adapter device's housing is preferably designed to house: (i) an audio and/or visual data sensor or sensor device for collecting audio and/or visual data (e.g., image or video data); (ii) an audio and/or visual data controller for controlling operation of the audio and/or visual data sensor or sensor device; and (iii) an AI processor that provides instructions to the audio and/or visual data controllers. The housing may also include or incorporate connecting features that allow connection between the printed circuit board and the audio and/or the visual data controllers (e.g., by an SD card or via a USB cable). Further, the AI adapter device's printed circuit board may also include AI adapter device memory.

The systems and methods of operation and effective compositions obtained from the present teachings and arrangements, however, together with additional objects and advantages thereof, will be best understood from the following descriptions of specific embodiments when read in connection with the accompanying figures.

### BRIEF DESCRIPTION OF THE DRAWINGS

FIG. 1 shows an AI adapter device, according to preferred embodiments of the present arrangements, connected to a camera trap and strapped to a tree at a location of interest.

FIG. 2 shows a block diagram of certain internal hardware components associated with the AI adapter device of FIG. 1.

FIG. 3A shows a top side of a printed circuit board (“PCB”), used in the AI adapter device of FIG. 1, incorporating certain hardware components present at a location of interest for implementing a customized mathematical model (e.g., a deployable mathematical model) that is developed at a remote location (i.e., remote to the location of interest).

FIG. 3B shows a bottom side of the PCB from FIG. 3A exposing an arrangement of certain other hardware components for power regulation, data transmission and storage.

FIG. 4 shows a block diagram of a system, according to one embodiment of the present arrangements, including an AI processor for remotely customizing a predetermined mathematical model that describes a phenomenon occurring at a location of interest.

FIG. 5 shows a block diagram showing an arrangement, according to one embodiment of the present arrangements, of different salient component used for processing and training data, obtained from different sources and pertinent to a predetermined mathematical model, for remotely developing a customized mathematical model.

FIG. 6 shows a flow chart showing of a customizing method, according to one embodiment of the present teachings, for remotely developing a deployable model from a predetermined mathematical model that describes a phenomenon occurring at a location of interest.

### DETAILED DESCRIPTION OF THE DRAWINGS

In the following description, numerous specific details are set forth in order to provide a thorough understanding of the present teachings and arrangements. It will be apparent, however, to one skilled in the art that the present teachings and arrangements may be practiced without limitation to some or all these specific details. In other instances, well-known process steps have not been described in detail in order to not unnecessarily obscure the present teachings and arrangements.

The systems and methods of the present arrangements and teachings disclose techniques and tools that provide users an affordable, no-code platform providing domain-experts accessibility to rapidly create and deploy tailored AI models to the field. These users can create AI models fit for their needs (e.g., ranchers monitoring livestock lameness, pet owners autonomously spotting health issues in pets, government agencies monitoring and acting on endangered and invasive species locations, and researchers learning more about animals seen on site). In doing so, these systems and methods decrease costs associated with conventional techniques and tools for such needs, increase outcomes, enable immediate (and remote) interventions for time-sensitive scenarios, and reduce privacy/safety concerns around data collection.

The systems and methods of the present teachings and arrangements are particularly well-suited to address time-sensitive scenarios such as detection, identification, and notification of endangered or invasive species in real-time, spotting and alerting on signs of disease and lameness in livestock to enable rapid treatment, and monitoring expanses of land and water for specific environmental activities (e.g., whale activity near an active port). They provide end users the ability to deploy flexible and rapid ML models, without technical expertise, for adaptable workflows and environments.

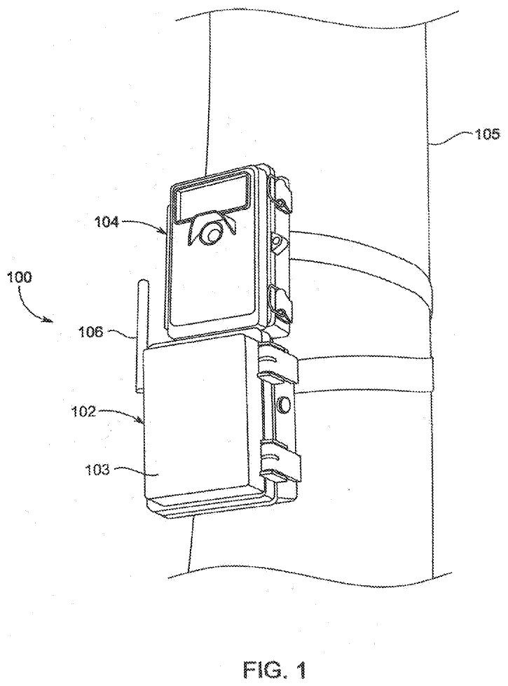

In one aspect, the present teachings disclose a data processing device that comprises an AI adapter device that retrofits existing sensor devices (e.g., camera traps, acoustic recorders) and/or actioning technologies (e.g., alarms, traps) with AI capabilities, including the ability to collect data and run AI models on such data at a location of interest to permit an inference (e.g., that image data collected by the sensor device identifies a particular species of interest). In doing so, the present arrangements and techniques provide for faster, more data-driven decisions, on the ground, by running local AI models on collected sensor data on-site to filter out non-relevant data and send back important in real time. To this end, FIG. 1 shows a data processing device 100 comprising an AI adapter device 102 connected to sensor device 104, according to one preferred embodiment of the present arrangements. As shown in FIG. 1, separate components of data processing device 100, i.e., AI adapter device 102 and sensor device 104, are each secured by straps to a tree 105 for collecting and processing data at a location of interest. A location of interest may be any area sought to be monitored by a user, and preferably, by a user that is remote to the location of interest.

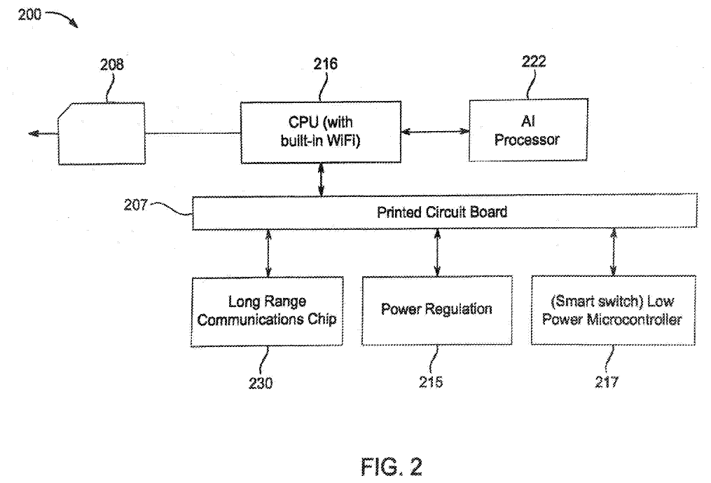

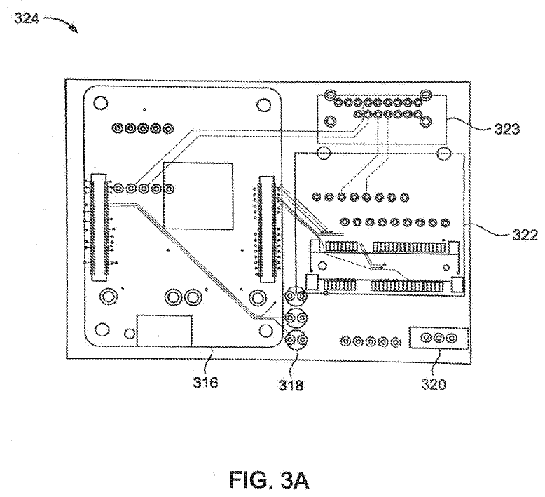

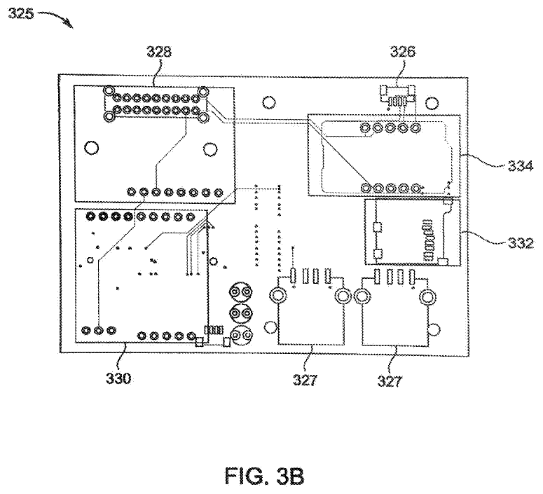

As shown in in FIG. 1, AI adapter device 102 includes a housing 103 and an antenna 106. Housing 103 is comprised of any material sufficient to protect internal components of device 100 (described below with references to FIGS. 2, 3A, and 3B) from anticipated or potential conditions at a location of interest (e.g., rain, snow, contact from debris). In one embodiment of the present arrangements, housing 103 is comprised of a waterproof case (e.g., IP66 or IP67). In those situations, where adapter device 100 is deployed under water, an IP68 housing is preferably used.

Housing 103 may have defined therein an opening that allows hardwiring to connect AI adapter device 102 and sensor device 104 via a connecting component, such as via a secure digital (“SD”) card slot or a USB port for transmitting data between AI adapter device 102 and sensor device 104. A connecting component and its associated components may also be thought of as a sensor device adapter. When connected in such manner, AI adapter device 102 provides AI functionality to sensor device 104. Among such AI functionality is the ability to collect data and run AI models using such data on-site at a location of interest. As used herein, an AI model is one or more machine learning algorithms that emulate logical decision-making based on available data.

Sensor device 104 is any data collection device, sensor device, or data logger used to collect data at a location of interest. In preferred embodiments of the present arrangements, sensor device 104 collects at least one member selected from a group comprising image data, video data, and acoustic data. The systems of the present arrangements, however, contemplate use of environmental sensor devices capable of collecting any other forms of data, such as temperature, pressure, humidity, and air quality. As shown in the embodiment of FIG. 1, sensor device 104 is a trail camera capable of recording images and/or video.

Preferably, sensor device 104 is a sensor device that is triggered to begin data collection by an event. By way of example, sensor device 104 may be triggered to capture image or video data upon detection of motion at a location of interest, or may be triggered to capture acoustic data upon detection of sound level, type, and/or frequency at a location of interest. This provides the advantage of decreasing power consumption during times when data collection is not necessary or warranted.

The ability to deploy and implement AI models on-site at a location of interest, where the user is remote to the location of interest, provides the advantage of filtering data and other outputs on the front-end and only sending data and other outputs as necessary from the AI adapter device. The present teachings recognize that conventional techniques and arrangements for remotely monitoring ecosystems and wildlife rely on four distinct “gates,” or stages, i.e., data collection, data communication, data storage, and data processing, to reach an end-user, with each stage's limitations, such as bandwidth, memory, range, and cost, flowing to the next, often leaving a user with an excess of useless or cryptic information, recurring costs, and technically infeasible use-cases. Use of the data processing devices of the present arrangements provide systems where processing (i.e., AI processing of collected data with a mathematical model) is performed onsite concurrent with or soon after data collection via a sensor device to filter unnecessary information to be transmitted to a user, which greatly reduces the burden of infrastructure, maintenance, and data management with sensor devices that can be forgotten until an event of interest is detected and with a reduced amount of data being transmitted and stored downstream. Moreover, once an event of interest is detected (e.g., a fishing boat illegally entering a marine-protected area at a location of interest), communication provisions associated with AI adapter device may be used to send a message to a user who is remote to the location of interest notifying the user of the event, and if necessary or desired, prompting the user to take action (e.g., sending a signal to or sounding an alarm at a fishing boat illegally entering a marine-protected area or notifying authorities of the illegal entry).

To this end, AI adapter device 102 also includes an antenna 106, which is communicatively coupled to components within housing 103 to facilitate long-range communications to and from AI adapter device 102. In certain embodiments of the present arrangements, antenna 106 facilitates communication over a wireless network. In other embodiments of the present arrangements, antenna 106 facilities communication over via LoRa, satellite, or a cellular network, so that data processing device 100 may be deployed in areas remote to a user without Internet service. In preferred embodiments of the present arrangements, communication with data processing device 100 is carried out via satellite, cellular, or Wi-Fi. Preferably, predetermined AI models, relevant datasets (including labeled and unlabeled data), databases, and other provisions necessary or helpful to creating and customizing AI models to be deployed to device 100 may be stored on the cloud or on a server or computer remote to a location of interest. Such communication features provide the advantage of allowing a user to operate device 100 remotely and in real-time and to deploy AI models and to receive data and information processed using an AI model from device 100 remotely and in real-time. By way of example, communication features may be used to trigger delivery of an email to a user when an event of interest occurs (e.g., detection of an invasive species based on an inference resulting from performance of an AI model on data collected by a sensor device) and the user may then remotely or automatically implement a response at the location of interest (e.g., trigger an alarm to scare away the invasive species).

Housing 103 also houses other components used to facilitate practice of the present teachings. To this end, FIG. 2 is a block diagram showing certain internal hardware components of an AI adapter device 202, according to preferred embodiments of the present arrangements. AI adapter device 202 is substantially similar to its counterpart in FIG. 1, i.e., AI adapter device 102.

The embodiment of FIG. 2 includes a printed circuit board (“PCB”) 207 configured with a CPU 216 (which is communicatively coupled to a sensor device adapter 208), an AI processor 222 (e.g., a central processing unit running an artificial intelligence system and built-in wireless networking technology to interface with the Internet), a long-range communications chip 230, provisions for power regulation 215, and a low-power microcontroller 217. Sensor device adapter 208 is capable of controlling action of a sensor device (e.g., a camera card controller). Preferably, CPU 216 and AI processor 222 work together to execute instructions to practice the present teachings on data collection device 100, with AI processor 222 being designed to perform the specific tasks associated with running AI algorithms more effectively than a more general use chip such as CPU 216. By way of example, CPU 216 may be used to load images obtained from sensor device 204 for running a selected AI model using AI processor 222. In certain embodiments of the present arrangements, however, one processor capable of performing the functions of CPU 216 and AI processor 222 is used.

FIGS. 3A and 3B show a PCB top side 324 and a PCB bottom side 325, respectively, of a PCB having certain hardware components disposed thereon, according to one preferred embodiment of the present arrangements. PCB top side 324 and PCB bottom side 325 may be thought of as a top side and a bottom side of PCB 207 of FIG. 2.

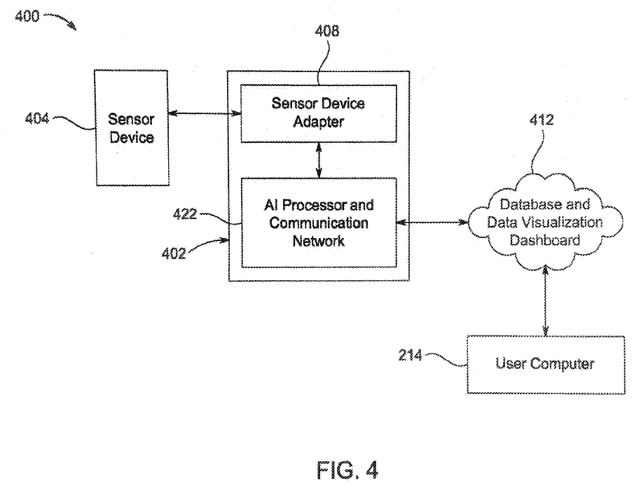

As shown in the embodiment of FIG. 3A, PCB top side 324 includes various hardware components that are disposed thereon, such as a Linux system-on-chip (“SoC”) 316 to run mathematical models that are presented and deployed on a user computer (e.g., user computer 414, discussed below with reference to FIG. 4). One example of such a system-on-chip includes, but is not limited to, Raspberry Pi Zero. PCB top side 324 may also include a specialized AI processor like Google Coral Tensor Processing Unit (“TPU”) 322 that runs AI algorithms. Examples of other features provided on PCB top side 424 include indicators LEDs 318, a mode slide switch 323, and a physical slide switch 320.

FIG. 3B shows a PCB bottom side 325, with certain other components disposed thereon. These include a low power microcontroller 334 as a watchdog timer or smart switch (e.g., Adafruit, Trinket, or Texas Instruments CC3220) to manage power cycling of an AI adapter device and to preserve battery life. PCB bottom side 325 also has provisions 330 for long-distance communication of information, e.g., a long range (“LoRa”) communications chip, as well as provisions for cellular and satellite communications.

For power regulation, for example, PCB bottom side 325 includes a custom power supply 328 that accommodates a power source (e.g., a lithium battery or a group of single electrochemical AA cell batteries) and may also accommodate a power cable such as a mini-USB power cable. An appropriately sized memory storage 332 is preferably included on PCB bottom side 325. Other features optionally provided on PCB bottom side 325 include a JST Connector 326 (e.g., 12C auxiliary sensors/communication connection points) and USB (e.g., Type A) x2 327 for auxiliary data input and 2x PCIe slots for communicative coupling, through cellular, wireless and/or satellite connection, to a user computer (e.g., user computer 414 of FIG. 4, discussed below).

Though the embodiments of PCB top side 324 and PCB bottom side 325 show each having examples of particular hardware components disposed thereon, the present teachings recognize that some or all of these particular hardware components may be disposed on either side of a PCB in various arrangements, along with other hardware components useful to practicing the systems and methods of the present teachings and arrangements.

In another aspect, the present arrangements and teachings disclose systems for customizing mathematical models to be deployed at a location of interest. To this end, FIG. 4 shows a block diagram of a system 400 for customizing mathematical models, according to one preferred embodiment of the present arrangements. System 400 includes a sensor device 404 connected to an AI adapter device 402 via a sensor device adapter 408, as well as an AI processor 422 with a communication network communicatively coupled to a cloud-based database and data visualization dashboard 412, which is in turn communicatively coupled to a user computer 414. AI adapter device 402 and sensor device 404 are substantially similar to their counterparts in FIG. 1 (i.e., AI adapter device 102 and sensor device 104). Sensor device adapter 408 and AI processor 422 are substantially similar to their counterparts in FIG. 3 (i.e., sensor device adapter 308 and AI processor 322).

AI processor 422 is any processor capable of running an AI system, or model, and that preferably includes built-in wireless networking technology to interface with the Internet and may also preferably include Bluetooth capability. AI processor 422 may run AI algorithms, process data received via sensor device adapter 407 from sensor device 404, and communicate insights from data obtained by sensor device 404 at a relatively low price point. To this end, AI processor 406 may have provisions for 500 MB buffer storage or more.

User computer 414 may be any user computer, including a desktop, laptop, and/or smartphone. User computer 414 includes a user interface, upon which, for example, a “marketplace of mathematical models” that defines one or more phenomena that are presented to a user. Preferably, the marketplaces of mathematical models or other repository of mathematical models contemplated by the present teachings is stored on cloud-based database and data visualization dashboard 412. The marketplace of models may be akin to a mobile software applications store in the way that users may browse, download, and install models at the click of a button. Moreover, such a model marketplace may serve as a hub for, among other things, data storage, finding and creating new models, managing the collective insights obtained from the different models (e.g., a user dashboard), set operating conditions of AI processor 422, and model deployment. The model marketplace also integrates with prevalent messaging systems so that important messages may be sent to the user at her/his convenience.

Cloud-based database and data visualization dashboard 412 may include and/or provide access to a server that includes provisions for training models, machine-learning algorithms, existing models, databases, data underlying models, additional data available for training models, storage, and/or supercomputing resources (e.g., processors and memory to perform training steps, such as from Google or Texas Advanced Computing Center).

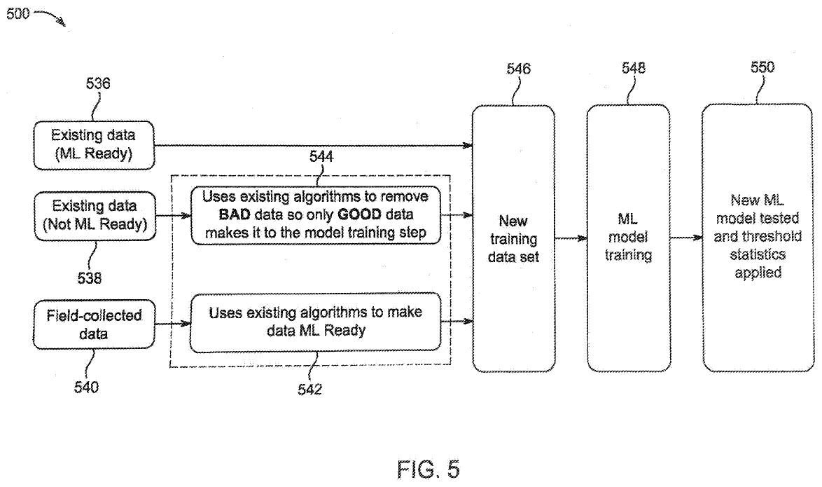

FIG. 5 shows a block diagram of a data processing scheme 500, according to one embodiment of the present arrangements, showing different configurations of data input used for training mathematical models that are selectable by a user using a computer (e.g., user computer 414 of FIG. 4). As will be explained below, the present teachings recognize that a model selected for customization may require additional training using data or data from different sources to enhance mathematical models that are susceptible to machine learning before they are deployed in the field.

According to data processing scheme 500 presented in FIG. 5, information or data may be classified into three primary categories, i.e., existing data 536, which is data in a format ready to be used for machine learning, existing data 538, which is data not in a format ready to be used for machine learning, and field-collected data 540, which is data that gathered using a sensor device (e.g., sensor device 104 of FIG. 1) or supplied by a user and modified by an AI processor (e.g., AI processor 222 shown in FIG. 2).

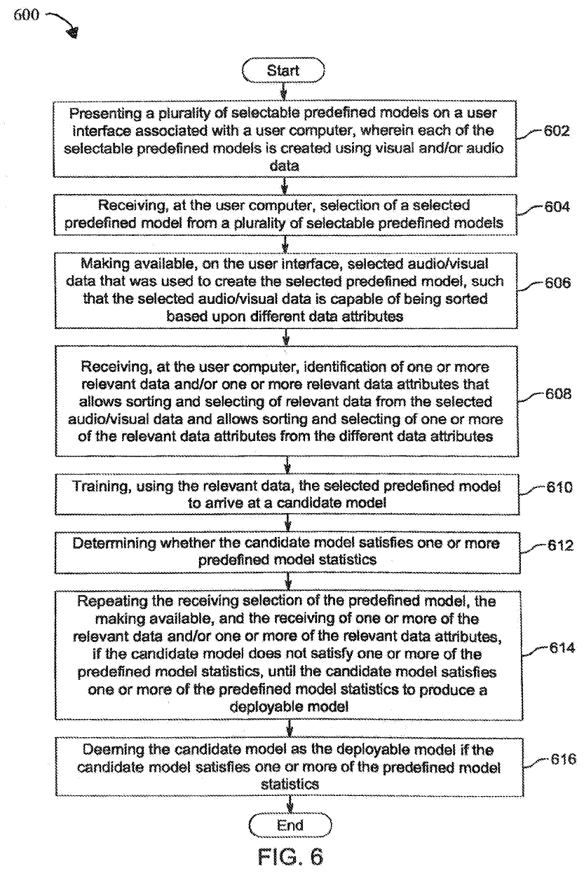

In the scheme shown in FIG. 5 and during a training process (e.g., step 610 of FIG. 6, discussed below), existing data 536, which is in a format ready to be used for machine learning, is, without further processing, deemed as “new training data set” 546 and advanced for machine learning model training 548. In certain embodiments of the present arrangements, existing data 536 is data that was used to train a selectable predefined model and that is preferably available to a user via the cloud (e.g., via cloud-based database and database and data visualization dashboard 412 of FIG. 4).

As a result of such training 548, scheme 500 is capable of carrying out a step 550 of providing a new machine-learned model. In step 550, the new machine-learned model is tested and threshold predefined model statistics are applied to ensure that it is a deployable model (discussed below with reference to FIG. 6).

In scheme 500 shown in FIG. 5, both existing data 538 that is not in a format to be directly processed for machine learning and field-collected data 540 require a certain amount of processing to be ready for machine learning. In the case of existing data not ready for machine learning, existing machine learning algorithms are used as filters to remove bad or unusable data in a step 544 before implementing a training step. As a result of such filtering, only the remaining good data from existing data 538 is deemed as “new training data set” 546 and advanced for machine learning model training 548. Similarly, field collected data undergoes a step 542 of filtering, using existing machine learning algorithms as a filter to remove bad or unusable data before implementing a training step. In this case also, only the remaining good data from field-collected data 540 is deemed as “new training data set” 546 and advanced for machine learning model training 548. These two different types of data, i.e., existing data 538 and field-collected data 540, are subjected to step 550 of providing a new machine-learned model. As explained above, in step 550, the new machine-learned model is tested, and threshold statistics are applied to ensure that it is a deployable model.

In those embodiments where existing data 538 and/or field-collected data 540 require a some amount of processing to prepare for machine learning, or training, the present teachings provide steps for labeling data and preparing data for subsequent machine-learning steps, including training. To this end, labeling data may be carried out by any technique well known to those of skill in the art. For example, labeling image data (e.g., images of cattle to detect lameness of cattle in subsequent steps) may be carried out by labeling individuals of interest within images by bounded box and class. As another example, labeling video data may be carried out by labeling individuals of interest within frames by bounded box and class, with behaviors of individuals tracked by start-stop periods. Further still, acoustic files may be labeled by start, stop, and class observed.

Following this labeling step, labeled datasets are prepared for training by packaging metadata into files that are capable of being used in a training step. With respect to labeled image and video datasets, preparing may be performed, for example, by a Docker container or, as another example, directly in Python. With respect to acoustic files, these may be processed with custom digital signal processing (“DSP”) techniques such as Mel-filterbank energy and spectral analysis to produce data similar to an image file.

In another aspect, the present teachings provide methods of allowing a user to automatically create a customized model that permits an inference. To this end, FIG. 6 shows a process 600 of allowing a user to automatically create a customized model that permits an inference, according to one preferred embodiment of the present arrangements.

Process 600 begins with a step 602, which includes presenting a plurality of selectable predefined models on a user interface associated with a user computer (e.g., user computer 414 shown in FIG. 4). In this step, each selectable predefined model was created using visual and/or audio data (e.g., data gathered from audio, image, or video sensor devices). In other embodiments of the present arrangements, however, other types of data are gathered, such as temperature, pressure, humidity, and air quality.

Upon presenting a plurality of selectable predefined models, a user selects a model for training in subsequent steps. By way of example, a user interested in customizing a model for identification of a Florida panther (a sub-species of a cougar) may select a predefined model for identification of cougars for further training to arrive a model for the more specific identification of a Florida panther. Preferably, presenting a plurality of the selectable predefined models includes presenting the models on an Internet website or a software application interface that is generated at a user computer (e.g., on a marketplace of models preferably conveyed from cloud-based database and data visualization dashboard 412 shown in FIG. 4).

Next process 600 proceeds to a step 604, which includes receiving, at the user computer, the selection of a selected predefined model from the plurality of selectable predefined models. By way of example, when a user selects (e.g., double clicks on) a predefined model, which is presented on the user interface, the user computer receives notification of the selection. Continuing the example from step 602, the selected model for identification of a cougar is received by the user computer. According to preferred embodiments of the present arrangements, a user computer has access to cloud-based storage to provide access to, among other things, the plurality of selectable predefined models from the cloud (e.g., from cloud-based database and data visualization dashboard 412 of FIG. 4).

In response, process 600 proceeds to a step 606, which includes the user computer making available, on the user interface, selected audio/visual data that was used to create the selected predefined model. In this step, the selected audio/visual data underlying the selected predefined model (e.g., existing data 536 of FIG. 5, which is preferably accessible via the cloud in database 412 of FIG. 4) is capable of being sorted based upon, among other things, different data attributes. Non-limiting example of data attributes include date of creation of relevant data, time of creation of relevant data, location coordinates of location from where relevant data was retrieved, species involved in relevant data, taxonomy, and data fields.

In certain embodiments of the present teachings, other data may be made available in this and subsequent steps. As explained above, non-ML-ready data may be prepared for machine learning and training in subsequent steps by labeling such data and/or preparing such data for machine-learning, including training. Likewise, a user may supply additional data (e.g., field-collected data 540 of FIG. 5) for use by the present teaching by labeling and preparing data for subsequent machine-learning steps, including training.

Next, process 600 proceeds to a step 608, which includes receiving, at the user computer, identification of one or more relevant data and/or one or more relevant data attributes that allows sorting and selecting of relevant data from the selected audio/visual data. In this step, the user may be presented various user options and select, from one or more of the data and/or one or more of the different data attributes, one or more of the relevant data and/or one or more of the relevant data attributes. By way of example, a user developing a model using video data to determine lameness in cattle may choose as relevant data for training in subsequent steps video of healthy cattle walking, video of cattle demonstrating mild symptoms of lameness, video of cattle demonstrating medium symptoms of lameness, and video of cattle demonstrating severe symptoms of lameness. Such video data may be provided to and/or supplied by the user in ML-ready form, or if not in ML-ready form, video data may be labeled and/or prepared for training.

Using the relevant data, process 600 proceeds to a step 610, which includes training of the selected predefined model to arrive at a candidate model. Training in step 610 may be thought of as transforming datasets into a candidate model file or files that can be used to perform an inference in subsequent steps, including at an AI adapter device that is part of a data collection device. A candidate model may be thought of as a model that will be tested for reliability and accuracy in subsequent steps. As used herein, inference means a conclusion reached based on results from using the candidate model to evaluate collected data. Training is performed by or at a user computer, in the cloud, and/or at a processor that is remote from an AI adapter device (e.g., AI adapter device 102 of FIG. 1).

The present teachings recognize that due to the fluid nature of software development, the processes for training in step 610 may change over time, but the inputs and outputs to and from step 610 remain the same. In particular, inputs to step 610 preferably include metadata files (including object class and position of objects within images or video stills), permissions, directions, data of the files used in training. The present teachings further recognize that any such parameters may be selected by a user or pre-preprogrammed prior to step 610.

Once step 610 is performed, outputs to step 610 (i.e., after training has been performed) include, by way of example, a candidate model provided in particular formats, for example, SavedModel for use on laptop/desktop computers) or Tensorflow Lite Models (e.g., optimized for use on low-power remote devices such as an AI adapter device, such as Float32, Int8, or Int8 optimized for Google Coral software.

In certain embodiments of the present teachings, training in step 610 is performed by using standardized transfer learning techniques, where input is the relevant data and data attributes, and the output is the model produced in step 610. Training in step 610 is preferably carried out using a containerized method such as Docker to enable training in step 610 on any system. In other embodiments of the present arrangements, an Edge Impulse training block is used for training in step 610 to produce a candidate model. This provides the advantages of reduced effort required to maintain dependencies, reduced costs, and increased options for domain-specific base models (e.g., a highly trained animal detector model can more easily be trained to spot a jaguar, compared to a general model used for spotting places or pencils).

Training in step 610 preferably includes using a situational awareness bias attribute to identify the candidate model. In the context of step 610, situational awareness bias may be thought of as using clues and context associated with the environment where data is being recorded to support a certain inference. According to one embodiments of the present arrangements, a situational awareness bias attribute includes at least one attribute chosen from a group that comprises geographical data of the relevant data, temporal data of the relevant data, weather conditions during retrieval of the relevant data, and previous inferences drawn from the relevant data. Continuing the above example of identifying presence of a Florida panther, awareness that Florida panthers are nocturnal animals is a situational awareness bias attribute that may be used to support an inference that an animal detected during daytime is less likely to be a Florida panther.

In certain embodiments of the present arrangements, training in step 610 further includes: (i) receiving relevant data that includes one or more usable portions and one or more unusable portions, wherein the usable portion are capable of being used for carrying out training, and wherein one or more of the unusable portions are not capable of being used for carrying out of training; (ii) filtering out, using one or more algorithms, unusable portions of the relevant data; and (iii) proceeding to training the selected predefined model using one or more usable portions of the relevant data.

Next, process 600 proceeds to a step 612, which includes determining whether the candidate model satisfies one or more predefined model statistics. By way of non-limiting example, predefined model statistics may include, but are not limited to, accuracy, precision, recall, F1 Score, or Confusion Matrix. If the candidate model satisfies predetermined model statistics, then the process proceeds to a step 616, described below. In certain embodiments of the present arrangements, predetermined model statistics are determined based on known labeled datasets that are supplied prior to step 610, which are then used to test the output candidate model from step 610 in step 612.

If the candidate model does not satisfy one or more of the predefined model statistics, however, then process 600 may include an optional step 614, which includes repeating at least two of step 604 (i.e., receiving selection of the predefined model), step 606 (i.e., making available), step 608 (i.e., receiving identification of one or more of the relevant data and/or one or more of the relevant data attributes), step 610 (i.e., training to arrive at the candidate model), and step 612 (i.e., determining whether the candidate model satisfies one or more of the predefined model statistics), until the candidate model satisfies one or more of the predefined model statistics to produce a deployable model. In other words, the present teachings contemplate a feedback loop whereby relevant steps of process 600 are repeated until development of a deployable model is achieved and confirmed by predefined model statistics.

The above-described steps of presenting and/or training preferably include obtaining, using one or more visual and/or audio sensors, the visual and/or audio data. In this embodiment, the exemplar process further includes: (i) conveying instructions regarding one or more of the relevant data attributes to one or more controllers that control operation of the visual and/or audio sensors; and (ii) changing, based upon the instructions, conditions of collecting the relevant data implemented by one or more of the visual and/or audio sensors to produce at least a portion of the relevant data. In other embodiments of the present teachings, however, other types of data (i.e., non-visual and non-audio data) are used. In certain embodiments of the present teachings, changing includes producing a portion of, and not all, relevant data.

In one embodiment of the present teachings, the process further includes receiving relevant data that includes one or more usable portions and one or more unusable portions. In this step, the usable portion is capable of being used for carrying out the training, and one or more of the unusable portions is not capable of being used for carrying out training. In this embodiment, the exemplar process further includes filtering out, using one or more algorithms, unusable portions of the relevant data, and training the selected predefined model using one or more usable portions of the relevant data.

The present teachings further provide processes for deploying a deployable model. To this end, the exemplar process further includes: (i) deploying the deployable model in the user computer, an AI adapter device, or a remote processor to permit an inference, wherein the remote processor is present at a location remote to a location of the AI adapter device; (ii) determining whether the inference satisfies one or more predefined inference criteria; and (iii) deeming the deployable model as final model, if the inference satisfies one or more of the predefined inference criteria, and modifying the deployable model, if the inference does not satisfy one or more of the predefined inference criteria, until the deployable model satisfies one or more of the predefined inference criteria to produce the final model. By way of non-limiting example, predefined inference criteria may include, but are not limited to, inference time (i.e., speed), precision and accuracy metrics (e.g., classification accuracy, F1, Mean Average Precision (mAP)).

According to one embodiment of the present teachings, process 600 further includes conveying the deployable model and/or audio and/or visual data associated with the deployable model from the user computer or the remote processor to an AI adapter device, if deeming is carried out by the user computer or the remote processor (i.e., a processor that is remote to the AI adapter device). In certain embodiments of the present teachings, the deployable model is stored on a remote memory that is accessible by a remote processor (i.e., remote to the location of the AI adapter device). Conveying may also include conveying from the memory accessible by the user computer or the remote memory accessible by the remote processor (i.e., remote to the AI adapter device) to the AI adapter device.

Process 600 may include the further steps of: implementing the final model on the AI adapter device; and, taking an action, using the AI adapter device, at the location of interest to conserve human, animal and/or plant life. In other words, the final model that was created in validated in previous steps is delivered to the AI adapter device at the location of interest to run the model and make one or more resulting inferences. Based on such inferences, the AI adapter device takes an action that facilitates conservation efforts, including conserving human, animal, and/or plant life. By way of example, upon detection of an invasive species at a location of interest, an AI adapter device may prompt, directly or indirectly, delivery of an email to a user or a third party who may then take further action to facilitate conservation efforts. As another example, upon detection of hunting dogs (e.g., via an audio sensor device), an AI adapter device may prompt, directly or indirectly, an alarm to sound at the location of interest to frighten away hunters, hunting dogs, and/or their intended prey. While use of the systems and methods of the present teachings to promote or facilitate environmental conservation efforts represents preferred embodiments of the present teachings, other uses of the systems and methods of the present teachings and arrangements are contemplated for monitoring conditions based on data collected at a location of interest. For example, the systems and methods of the present teachings may be used to monitor disease in livestock by evaluating sick versus healthy behavioral traits, for monitoring pet health or safety, or the like.

Implementing the final model may also include conveying final data and/or final data attributes underlying the final model, where the final data includes one or more new data not present in the relevant data and/or does not include one or more excised data that were present in the relevant data, and the final data attributes includes one or more new data attributes not present in the relevant data attributes and/or does not include one or more excised data attributes that were present in the relevant data attributes. In other words upon conveyance of a final model to an AI adapter device, conveyance of data and data attributes that are different from those associated with a candidate model.

In another aspect, the present teachings disclose a process for facilitating environmental conservation, according to preferred embodiments of the present arrangements. As used herein, environmental conservation means protecting and preserving natural resources and plant and animal life from deleterious effects of human activity. To this end, an exemplar process for facilitating environmental conservation begins with a step of creating a mathematical model, using data and/or one or more data attributes and that is describing a phenomenon involving a human, animal and/or plant presence or behavior at a location of interest. As one example, a user interested in facilitating environmental conservation may create a mathematical model configured to identify an endangered species of a particular type for purposes of tracking population levels of that species. Creating a mathematical model may further include steps of obtaining data (e.g., image, video, and/or acoustic data), labeling the data, and preparing the data for machine learning, as described above with reference to FIGS. 5 and 6.

Next, the exemplar process for facilitating environmental conservation proceeds to a step of training the mathematical model to arrive at a candidate model using the data, new data, one or more data attributes, and/or one or more new data attributes, according to one embodiment of the present arrangements. Training in this step is carried it in a manner substantially similar to that described above with respect to step 610 of FIG. 6.

Next, the exemplar process proceeds to a step of determining whether the candidate model satisfies one or more predefined model statistics, which is substantially similar to step 612 described above with reference to FIG. 6.

Next, if the candidate model does not satisfy the predefined model statistics, the above steps of creating, training, and determining may be repeated until the candidate model satisfies the predefined model statistics. If the candidate model satisfies one or more of the predefined model statistics, then it is deemed to be a deployable model. These steps are substantially similar to their counterparts described above with reference to FIG. 6 (i.e., steps 614 and 616).

In preferred embodiments of the present teachings, the steps of training the mathematical model, determining whether the candidate model satisfies one or more predefined model statistics, and deeming the deployable model to be a final mode are carried out at the user computer or the processor that is present at a location that is remote to the location of the AI adapter device.

Next, the deployable model is deployed to a user computer, an AI adapter device, and/or a remote processor (i.e., remote to a location of interest) to permit an inference. Preferably, the user computer and the remote processor are present at a location that is remote to the location of the AI adapter device.

Next, the exemplar process for facilitating environmental conservation proceeds to a step of determining whether the inference satisfies one or more predefined inference criteria (e.g., classification accuracy). Then, if the inference satisfies one or more of the predefined inference criteria, the deployable model is deemed a final model. If, however, the inference does not satisfy one or more of the predefined inference criteria, then the deployable manner is modified (i.e., as explained above with customizing a model with reference to process 600 of FIG. 6), preferably until one or more predefined inference criteria are satisfied according to this step.

Next, the final model is implemented on the AI adapter device to draw an inference.

According to preferred embodiments of the present teachings, a particular inference may prompt further action that will facilitate environmental conservation efforts, e.g., by conserving human, animal, or plant life, as well as other natural resources. According to one preferred embodiment of the present teachings, and as explained above, taking action includes sending a notification to a user computer and/or a third party, setting a trap, sounding an alarm, recording an image or a video, recording a sound, depleting resources consumed by an invasive animal or a plant species, dispersing food, administering medicine/vaccines, among other actions.

Although illustrative embodiments of the present arrangements and teachings have been shown and described, other modifications, changes, and substitutions are intended. Accordingly, it is appropriate that the appended claims be construed broadly and in a manner consistent with the scope of the disclosure, as set forth in the following claims.

What is claimed is:

1. A process for allowing a user to automatically create a customized model that permits an inference, said process comprising:
presenting a plurality of selectable predefined models on a user interface associated with a user computer, wherein each of said selectable predefined model is created using visual and/or audio data;
receiving, at said user computer, selection of a selected predefined model from plurality of said selectable predefined models;
making available, on said user interface, selected audio/visual data that was used to create said selected predefined model, such that said selected audio/visual data is capable of being sorted based upon different data attributes;
receiving, at said user computer, identification of one or more relevant data and/or one or more relevant data attributes that allows sorting and selecting of relevant data from said selected audio/visual data and allows sorting and selecting of one or more of said relevant data attributes from said different data attributes;
training, using said relevant data and/or said relevant data attributes, said selected predefined model to arrive at a candidate model;
determining whether said candidate model satisfies one or more predefined model statistics;
deeming said candidate model as a deployable model if said candidate model satisfies one or more of said predefined model statistics.

2. The process of claim 1 of allowing a user to automatically create a customized model that permits an inference, further comprising repeating at least two of said receiving selection of said predefined model, said making available, said receiving of one or more of said relevant data and/or one or more of said relevant data attributes, said training to arrive at said candidate model and said determining whether said candidate model satisfies one or more of said predefined model statistics, if said candidate model does not satisfy one or more of said predefined model statistics, until said candidate model satisfies one or more of said predefined model statistics to produce a deployable model.

3. The process of claim 1 of allowing a user to automatically create a customized model that permits an inference, wherein said presenting of plurality of said selectable predefined models includes presenting on an Internet website or a software application interface that is generated at said user computer.

4. The process of claim 1 of allowing a user to automatically create a customized model that permits an inference, wherein said receiving identification of one or more of said relevant data attributes includes receiving at least one attribute chosen from a group comprising date of creation of said relevant data, time of creation of said relevant data, location coordinates of location from where said relevant data was retrieved, species involved in said relevant data and animal present in said relevant data.

5. The process of claim 1 of allowing a user to automatically create a customized model that permits an inference, wherein said training includes using situational awareness bias attributes to identify said candidate model, and wherein said situational awareness bias attributes include at least one attribute chosen from a group comprises geographical data of said relevant data, temporal data of said relevant data, weather conditions during retrieval of said relevant data, and previous inferences drawn from said relevant data.

6. The process of claim 1 of allowing a user to automatically create a customized model that permits an inference, wherein said presenting and/or said training including obtaining, using one or more visual and/or audio sensors or said visual and/or audio data.

7. The process of claim 6 of allowing a user to automatically create a customized model that permits an inference, further comprising:
conveying operational instructions pertinent to one or more of said relevant data attributes to one or more controllers that control operation of said visual and/or audio sensors; and
changing, based upon said operational instructions, operating conditions of said visual and/or audio sensors for collecting said relevant data to produce at least a portion of said relevant data.

8. The process of claim 7 of allowing a user to automatically create a customized model that permits an inference, wherein said changing includes producing a portion, and not entire, of said relevant data.

9. The process of claim 1 of allowing a user to automatically create a customized model that permits an inference, wherein said training further comprises:
receiving relevant data that includes one or more usable portions and one or more unusable portions, wherein said usable portion are capable of being used for carrying out said training, and wherein one or more of said unusable portions are not capable of being used for carrying out of said training; and
filtering out, using one or more algorithms, unusable portions of said relevant data; and
training said selected predefined model using one or more usable portions of said relevant data.

10. The process of claim 1 of allowing a user to automatically create a customized model that permits an inference, further comprising:
deploying said deployable model in said user computer, an AI adapter device, or a remote processor to permit an inference, wherein said remote processor is present at a location remote to a location of said AI adapter device;
determining whether said inference satisfies one or more predefined inference criteria; and
deeming said deployable model as final model, if said inference satisfies one or more of said predefined inference criteria, and modifying said deployable model, if said inference does not satisfy one or more of said predefined inference criteria, until said deployable model satisfies one or more of said predefined inference criteria to produce said final model.

11. The process of claim 10 of allowing a user to automatically create a customized model that permits an inference, further comprising conveying said deployable model and/or audio and/or visual data associated with said deployable model from said user computer or said remote processor to said AI adapter device, if said deeming is carried out by said user computer or said remote processor.

12. The process of claim 11 of allowing a user to automatically create a customized model that permits an inference, further:
comprising implementing said final model on said AI adapter device; and
taking an action, using said AI adapter device, at said location of interest to conserve said human, said animal and/or said plant life.

13. The process of claim 11 of allowing a user to automatically create a customized model that permits an inference, wherein in said deploying, said deployable model is stored on a remote memory accessible by said remote processor, and wherein said remote memory is present at a location remote to said location of said AI adapter device.

14. The process of claim 13 of allowing a user to automatically create a customized model that permits an inference, wherein said conveying includes conveying from said memory accessible by said user computer or said remote memory accessible by said remote processor to said AI adapter device.

15. The process of claim 14 of allowing a user to automatically create a customized model that permits an inference, wherein said conveying said final model includes conveying final data and/or final data attributes underlying said final model, wherein said final data includes one or more new data not present in said relevant data and/or does not include one or more excised data that were present in said relevant data, and said final data attributes includes one or more new data attributes not present in said relevant data attributes and/or does not include one or more excised data attributes that were present in said relevant data attributes.

16. A process for facilitating environmental conservation comprising:
creating a mathematical model, using one or more data and/or one or more data attributes and that is describing a phenomenon involving a human, animal, and/or plant presence or behavior at a location of interest;
training said mathematical model to arrive at a candidate model using said data, new data, one or more said data attributes and/or one or more new data attributes;
determining whether said candidate model satisfies one or more predefined model statistics;
repeating said creating, said training and said determining, if said candidate model does not satisfy one or more of said predefined model statistics, until said candidate model satisfies one or more of said predefined model statistics to produce a deployable model; and
deeming said candidate model as said deployable model if said candidate model satisfies one or more of said predefined model statistics;
deploying said deployable model on said user computer, an AI adapter device, and/or a remote processor to permit an inference; wherein said user computer and said remote processor are present at a location that is remote to location of said AI adapter device;
determining whether said inference satisfies one or more predefined inference criteria;
deeming said deployable model as final model, if said inference satisfies one or more of said predefined inference criteria, and modifying said deployable model, if said inference does not satisfy one or more of said predefined inference criteria, until said deployable model satisfies one or more of said predefined inference criteria to produce said final model;
implementing said final model on said AI adapter device to draw an inference; and
taking an action, using said AI adapter device, at said location of interest to conserve said human, said animal and/or said plant life.

17. The process of facilitating environmental conservation of claim 16, further comprising conveying said final model to an AI adapter device, if said final model resides on said user computer and/or said remote processor, and wherein said conveying is carried out after said deeming and prior to said implementing.

18. The process of facilitating environmental conservation of claim 16, wherein said training, said determining and said deeming are carried out at said user computer or said processor present at said location that is remote to said location of said AI adapter device.

19. The process of facilitating environmental conservation of claim 16, wherein said taking an action includes one action chosen from a group comprising sending a notification to said user computer and/or a third party, setting a trap, sounding an alarm, recording an image or a video, recording a sound, depleting resources consumed by an invasive animal or a plant species, dispersing food, monitoring animal or plant health, and administering medicine or vaccine.

20. An audio/visual data processing device comprising:
an audio sensor and/or a visual sensor;
an AI adapter device comprising:
an audio controller and/or a visual controller that is designed to control operation of said audio sensor and/or said visual sensor;
an AI processor for processing data collected from said audio sensor and/or said visual sensor; and
a power source for powering said AI processor.

21. The audio/visual data processing device of claim 20, further comprising a connecting component communicatively connecting said audio sensor and/or said visual sensor to said AI adapter device.

22. The audio/visual data collection device of claim 20, further comprising a user computer or a remote processor having programmed thereon instructions for allowing a user to automatically create a customized model that permits an inference and/or deployment of said customized model to permit said inference, wherein a memory accessible by said user computer or a remote memory accessible by said remote processor has stored thereon instructions for:
training said mathematical model to arrive at a candidate model using said data, new data, one or more said data attributes and/or one or more new data attributes;
determining whether said candidate model satisfies one or more predefined model statistics;
repeating said creating, said training and said determining, if said candidate model does not satisfy one or more of said predefined model statistics, until said candidate model satisfies one or more of said predefined model statistics to produce a deployable model;
deeming said candidate model as said deployable model if said candidate model satisfies one or more of said predefined model statistics;
deploying said deployable model to permit an inference;
determining whether said inference satisfies one or more predefined inference criteria;
deeming said deployable model as final model, if said inference satisfies one or more of said predefined inference criteria, and modifying said deployable model, if said inference does not satisfy one or more of said predefined inference criteria, until said deployable model satisfies one or more of said predefined inference criteria to produce said final model;
conveying said final model to said AI adapter device.

23. The audio/visual data collection device of claim 20, wherein said AI processor, said communication component, and said power source are on a single printed circuit board.

24. The audio/visual data collection device of claim 20, wherein said AI processor is a central processing unit that has disposed thereon said communication component which serves to establish a wireless local area network connection.

25. The audio/visual data collection device of claim 20, wherein said communication component is communicatively coupled to a cloud-based database.

26. The audio/visual data collection device of claim 20, wherein said printed circuit board further comprising a long-range communication chip for communicating using low-power wide area network, cellular, or satellite communications.

27. The audio/visual data collection device of claim 20, wherein said AI processor further comprising an AI adapter device memory having stored thereon instructions for:
deploying said deployable model to permit an inference;
determining whether said inference satisfies one or more predefined inference criteria;
deeming said deployable model as final model, if said inference satisfies one or more of said predefined inference criteria, and modifying said deployable model, if said inference does not satisfy one or more of said predefined inference criteria, until said deployable model satisfies one or more of said predefined inference criteria to produce said final model;
implementing said final model to draw an inference; and
taking an action at said location of interest.

28. The audio/visual data collection device of claim 27, wherein said housing is designed to house therein:
an audio and/or visual data sensor for collecting audio and/or visual data;
an audio and/or visual data controllers for controlling operation of said audio and/or said visual data sensor;
an AI processor that provides instructions to said audio and/or said visual data controllers; and
wherein said housing has connecting features that allow connection between said printed circuit board and said audio and/or said visual data controllers, and wherein said printed circuit board includes said AI adapter device memory.
